(19) United States
(12) Patent Application Publication
(10) Pub. No.: US 2026/0101392 A1
(43) Pub. Date: Apr. 9, 2026

(54) PARALLEL COEXISTENCE WITH A PEER TO PEER COMMUNICATION PROTOCOL

(71) Applicant: Apple Inc., Cupertino, CA (US)

(72) Inventors: Camille Chen, Cupertino, CA (US); Hsin-Yao Chen, Castro Valley, CA (US); Lynn E. Greiner, Santa Clara, CA (US); Ramachandran Sathyanarayanan, San Jose, CA (US); William F. Healey, Sunnyvale, CA (US)

(21) Appl. No.: 19/113,205

(22) PCT Filed: Sep. 20, 2023
(86) PCT No.: PCT/US2023/033220

§ 371 Date: Mar. 19, 2025

Related U.S. Application Data
(60) Provisional application No. 63/409,133, filed on Sep. 22, 2022.

(51) Int. Cl. H04W 76/14; H04W 74/04; H04W 84/10

(52) U.S. Cl. CPC H04W 76/14; H04W 74/04; H04W 84/10

(57) ABSTRACT

Disclosed are methods, systems, and computer-readable media to perform operations in a wireless device that includes a first radio that operates according to a wireless P2P protocol and a second radio that operates according to a second wireless protocol. The operations include using device properties to determine to use the wireless P2P protocol and the second wireless protocol in parallel, and in response, determining transmission characteristics for the wireless P2P protocol and the second wireless protocol. The operations also include instructing the first radio to perform a first action according to the wireless P2P protocol and the transmission characteristics, and instructing the second radio to perform a second action according to the second wireless protocol and the transmission characteristics. The transmission characteristics can include an antenna, a radio frequency (RF) band, a stream, and protocol features for each of the P2P protocol and second wireless protocol.

### CROSS-REFERENCE TO RELATED APPLICATIONS

The present application claims priority to U.S. Provisional Application No. 63/409,133, filed on Sep. 22, 2022, entitled “PARALLEL COEXISTANCE WITH A PEER TO PEER COMMUNICATION PROTOCOL,” which is incorporated herein by reference in its entirety.

### TECHNICAL FIELD

This disclosure relates to radio coexistence in wireless communication systems.

### BACKGROUND

Electronic devices include radios and antennas to connect to other devices through WiFi and Bluetooth. Data packets can be transmitted on WiFi networks using different frequency bands (e.g., 2.4 GHz and 5 GHz). The electronic devices can use Simultaneous Dual Band (SDB) to connect with two separate WiFi networks simultaneously.

### SUMMARY

Multiple communication protocols share the wireless resources of an electronic device through the use of coexistence policies. The electronic device includes radios corresponding to the communication protocols which are communicatively coupled to an antenna. In some embodiments, a wireless communication system of the electronic device can use a Simultaneous Dual Band (SDB) to transmit/receive (Tx/Rx) wireless signals on different frequency bands at the same time.

In accordance with aspects of the present disclosure, a method for wireless communicating is disclosed. The method can be performed in a wireless device that includes a first radio that operates according to a first wireless protocol and a second radio that operates according to a second wireless protocol. The method involves instructing the first radio to perform a first action according to the first wireless protocol using a first radio frequency (RF) band; determining a second RF band based on the first RF band; and instructing the second radio to perform a second action according to the second wireless protocol using the second RF band.

In accordance with aspects of the present disclosure, a method for wireless communicating is disclosed. The method can be performed in a wireless device. The method involves determining a set of peer devices that satisfy a predetermined condition; triggering communications according to a wireless protocol for each peer device of the set of peer devices that satisfy the predetermined condition; and determining to skip communicating with peer devices that do not satisfy the predetermined condition.

The previously-described implementation can be performed using a computer-implemented method; a non-transitory, computer-readable medium storing computer-readable instructions to perform the computer-implemented method; a processor including circuitry to execute one or more instructions that, when executed, cause the processor to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, the first action and second action include transmitting data packets using the at least one antenna.

In some implementations, the first wireless protocol is a peer to peer (P2P) protocol, and the second wireless protocol is a Bluetooth protocol.

In some implementations, the first wireless protocol is restricted from using the second RF band.

In some implementations, the second wireless protocol can use the at least one shared antenna without restriction.

In some implementations, the at least one antenna includes at least one antenna dedicated to the second wireless protocol, and at least one shared antenna.

In some implementations, the actions further include determining the first wireless protocol is using the second RF band. In response to determining the first wireless protocol is using the second RF band, the second wireless protocol is restricted to use at least one antenna dedicated to the second wireless protocol.

In some implementations, the actions further include determining a time period for which the first protocol requires the second RF band. The second radio is restricted from performing the second action during the time period.

In some implementations, the actions further include determining the first wireless protocol is not using the second RF band. In response to determining the first wireless protocol, the second wireless protocol is allowed to use the at least one shared antenna without restriction.

In some implementations, determining the first wireless protocol is not using the second RF band includes determining a control signal for the second radio is in an intermediate state.

In some implementations, determining the set of peer devices that satisfy the predetermined condition includes scanning for peer devices on a wireless network.

The subject matter described in this specification can be implemented to realize one or more of the following advantages. The disclosed method enables improvement to the communication protocols by expanding functionality, reducing lag, and/or increasing data throughput. For example, the disclosed method enables advanced BT features to function during Apple Wireless Direct Link (AWDL) sessions.

The details of one or more implementations of the subject matter described in this disclosure are set forth in the accompanying drawings and the description. Other features, aspects, and advantages of the subject matter will become apparent from the description, the drawings, and the claims.

### BRIEF DESCRIPTION OF THE DRAWINGS

FIG. 1 illustrates an example environment for communicating wirelessly, according to some implementations.

FIG. 2 illustrates an example of sending action frames to synchronize among devices, according to some implementations.

FIG. 3 illustrates an example of a channel sequence for a coexistence scheme, according to some implementations.

FIG. 4 illustrates an example of a relationship between an AWDL channel sequence and the state of a 2G Core, according to some implementations.

FIG. 5 illustrates a flowchart of an example method, according to some implementations.

FIG. 6 illustrates a flowchart of an example method, according to some implementations.

FIG. 7 illustrates a flowchart of an example method, according to some implementations.

FIG. 8 illustrates an example computer system for implementing some of the disclosed embodiments or portion(s) thereof, according to some implementations.

Like reference numbers and designations in the various drawings indicate like elements.

### DETAILED DESCRIPTION

By way of background, IEEE 802.11 specifications contributed to the development of WiFi ad hoc networks (e.g., WiFi peer to peer [P2P])). By using WiFi P2P, devices can communicate with each other directly instead of going through an access point (AP). This type of communication has the advantages that (1) it does not require network infrastructure, and (2) it reduces the overhead traffic of the AP, among other advantages.

An example use of WiFi P2P is Apple Wireless Direct Link (AWDL). AWDL includes many features, such as auto-unlock (e.g., of two or more devices), sidecar, universal control, and enabling certain camera features. In some examples, WiFi Neighbor Awareness Network (NAN) can be used for coordinating home electronic devices, e.g., to provide low latency audio.

WiFi P2P performance has increased as a result of hardware advancements (e.g., advancements in silicon technology) and the implementation of features from the IEEE 802.11ac/ax/6E standard. For example, WiFi Multiple In, Multiple Out (MIMO) uses multiple transmitters and receivers to increase data throughput.

However, WiFi may be required to share resources between WiFi Infrastructure (i.e., WiFi Infra) and AWDL. As a result, WiFi Infra may be negatively affected if AWDL occupies too much bandwidth. In some scenarios, devices may need to send a “power saving” communication to the AP to hold WiFi Infra traffic when the device switches between WiFi Infra and AWDL channels. This overhead can increase the switching time. If the AP is dropping packets, the WiFi Infra data rate can drop significantly. Therefore, under existing protocols, the use of AWDL applications may be limited as a result of the impact on WiFi Infra.

In some embodiments, WiFi Infra and AWDL can work in parallel in different bands (e.g., 2.4 GHz and 5 GHz) if the hardware allows WiFi Simultaneous Dual Band (SDB). The hardware can include two cores (e.g., Main and Aux, 2G and 5G). For example, the 2G core can be used to transmit and receive data on the 2.4 GHz band, and the 5G core can be used to transmit and receive data on the 5 GHz band. By using SDB, the use and performance of AWDL applications (e.g., side car, universal control) can be improved. However, not all devices are capable of SDB. There is a need to determine a coexistence policy using the device properties.

This disclosure describes methods and systems for wirelessly communicating among electronic devices. A device can communicate with other devices using a coexistence between two wireless protocols (e.g., P2P protocols). For example, the first protocol can include AWDL and the second protocol can include a Personal Area Network (PAN). As described in more detail below, the PAN can include any communication protocol meeting any IEEE 802.15 standard (e.g., Thread, Zigbee, Bluetooth [BT]). The coexistence can be implemented based on the available hardware (e.g., number and configuration of antennas).

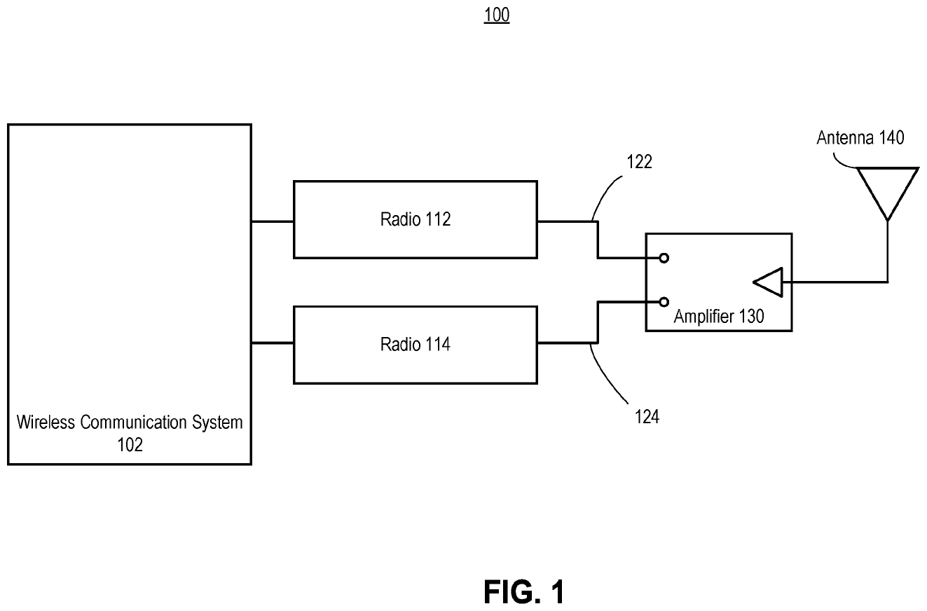

FIG. 1 illustrates an example environment 100 for communicating wirelessly, according to some implementations. The environment 100 can include a wireless communication system 102 for controlling a radio 112 and a radio 114. In some embodiments, the radio 112 can be used for a first wireless protocol (e.g., P2P, WiFi, AWDL), and the radio 114 can be used for a second wireless protocol (e.g., Bluetooth [BT]). In some embodiments, the radio 112 and/or the radio 114 can include a 2G core and a 5G core. The 2G core can be used for communicating on the 2.4 GHz band (i.e., 2G), and the 5G core can be used for communicating on the 5 GHz band (i.e., 5G).

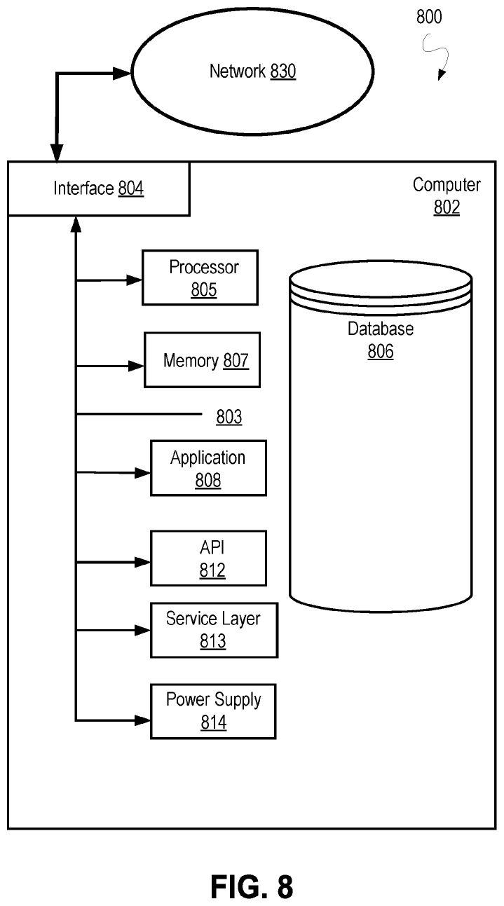

The radio 112 and the radio 114 are communicatively coupled to an antenna 140 via paths 122 and 124, respectively. The paths 122 and 124 can connect to the antenna 140 through an amplifier 108 (e.g., an external low noise amplifier [eLNA]). Note that the environment 100 is shown for illustration purposes only, as the environment 100 may include other components without departing from the scope of the disclosure. For example, the environment 100 may include other types of radios. Furthermore, the environment 100 and/or the wireless communication system 102 may be included in a computing system, such as the computing system 800 of FIG. 8.

In some embodiments, the radio 112 and the radio 114 use the antenna 140 in order to transmit and/or receive wireless signals. The radios 112 and 114 can control the antenna gain and/or the amplifier settings in order to optimize signal transmission/reception appropriate for the radio's own need. For example, the radio 112 can control the antenna gain and/or the amplifier settings in order to optimize for WiFi signal transmission/reception. In some examples, the radio 114 can control the settings of the antenna 106 and/or the settings of the amplifier 130 to be optimized for Bluetooth signals. In an embodiment, the wireless communication system 102 can include a WLAN/BT scheduler that controls which radio receives a signal from the antenna 140.

In some embodiments, the wireless communication system 102 can allow the radio 112 and the radio 114 to use the antenna 140 at the same time using SDB. In some embodiments, the wireless communication system 102 can plan AWDL and WiFi Infra channels in the same band. For example, the wireless communication system 102 can utilize an available hardware configuration (e.g., antenna isolation) to generate the channel sequence for AWDL and WiFi Infra completely in parallel in 2.4 GHz, 5 GHz, or both. In some embodiments, the wireless communication system 102 can use SDB to provide AWDL in one band (2.4 GHz, 5 GHz) and Infra in the other band. The 2.4 GHz band can include channels 1-14 and the 5 GHz band can include certain channels between 32 and 177 specified by IEEE 802.11a/h/j/n/ac/ax.

In some embodiments, the environment 100 can include at least one antenna in addition to antenna 140. For example, antenna 140 can be a shared antenna and another antenna can be a dedicated antenna (e.g., dedicated for BT). In some embodiments, the radio 112 and the radio 114 can control multiple antennas and operate on the multiple antennas simultaneously. Both the radio 112 and the radio 114 can be active at the same time, even if most of the WiFi activities are on 5G. In some embodiments, the environment 100 can include a WiFi/BT chip with two parallel WiFi cores. In such embodiments, WiFi is not restricted to multiple-input multiple-output (MIMO).

In some embodiments, when the first protocol is using 2G, the first protocol can acknowledge (ACK) single-input-single-output (SISO) data from one antenna, and the second protocol can send and receive data (e.g., transmit/receive [Tx/Rx]) from the other antenna. In some embodiments, the first protocol can send data on both antennas.

In some embodiments, the environment 100 can include three antennas. The antennas can include two antennas shared between the first and second protocols, and one dedicated antenna. When the first protocol is using 2G, the second protocol can send data from the dedicated antenna, and the first protocol can SISO ACK from one of the shared antennas. The remaining antenna can be shared by the first and second protocols for receiving data (e.g., Rx), and the first protocol can transmit data packets (e.g., Tx) on this antenna.

In some embodiments, the environment 100 can include a second dedicated antenna. In some embodiments, both dedicated antennas can be capable of advanced BT features. For example, the second dedicated BT antenna could be a fourth antenna.

In some embodiments, the second wireless protocol includes advanced BT features. Hardware and firmware can enable these BT features in order to provide optimal BT performance. The BT features can include Tx beam forming, (TxBF), Rx maximum ratio combining (MRC), external power amplifier (ePA), and external low noise amplifier (eLNA). ePA can be implemented as a hardware component that allows BT to transmit at a higher power, which gives an improved range to BT accessories. ePA can be used as an alternative to an internal power amplifier (iPA). ePA may not be available for BT dedicated antennas, and may only be included on the shared antennas. ePA can result in a better BT range (e.g., 50 ft increase) when BT is not restricted to using the dedicated BT antenna. TxBF and MRC require 2 antennas. In the system where antennas are shared (e.g., between WiFi and BT), when a first protocol (e.g., WiFi, P2P, AWDL) is in 2.4 GHz, BT may be limited to one antenna in order to balance performance between two or more protocols. In some embodiments, BT features can be suppressed when the first protocol is using 2G depending on the coexistence (coex) policy being used. Table 1, below, shows an example of how BT features can be suppressed, and the impact of different coex policies on BT performance (e.g., audio quality, BT range).

TABLE 1
BT Features and Restrictions in Different Coex Policies

| BT | | | |
|---|---|---|---|
| features | Requirements | Coex impact | Note |
| TxBF | Need 2 antennas | In hybrid coex, not | Hybrid requires 1 |
| | | supported | dedicated antenna |
| | | | for WiFi Tx ACK |
| MRC | Need 2 antennas | In hybrid coex, if it | Hybrid requires 1 |
| | | has no dedicated BT | dedicated antenna |
| | | antenna, not | for WiFi Tx ACK |
| | | supported | |
| ePA | Requires Tx chain | In hybrid coex, if | |
| | to have ePA | dedicated BT | |
| | | antenna has no ePA, | |
| | | not supported | |
| eLNA | Requires Rx chain | In hybrid coex, if | |
| | to have eLNA | dedicated BT | |
| | | antenna has no | |
| | | eLNA, not | |
| | | supported | |

Certain BT features may be suppressed while the first protocol is in 2.4 GHz and the wireless communication system 102 is using the hybrid or parallel coex policy.

In some embodiments, the wireless communication system 102 can use a coexistence (coex) policy (e.g., operating mode) based on the configuration of environment 100. The coex policy can include parallel policies and time sharing policies. While using the parallel coex policy, the first and second communication protocols can send and receive (Tx/Rx) data independently. Time sharing policies can include time division duplexing coex (TDD coex) and hybrid coex. While using the TDD coex, the wireless communication system 102 can split antenna time between the first and second protocols. While using the hybrid coex, the wireless communication system 102 can allow the first and second protocols to receive data (Rx/Rx) simultaneously. Table 2, below, shows an example of how BT and WiFi can coexist while using different policies (T: Time Sharing, S: Simultaneous).

TABLE 2
Coexistence policies

| WiFi | | BT | 2G TDD | 2G Hybrid | 2G Parallel | 5G Parallel |
|---|---|---|---|---|---|---|
| Tx | | Tx | T | T | S | S |
| Tx | Data Tx | Rx | T | T | S | S |
| | ACK/C | Rx | T | S | S | S |
| | TS Tx | | | | | |

| | | | | | |
|---|---|---|---|---|---|
| Rx | Tx | T | S | S | S |
| Rx | Rx | T | S | S | S |

The TDD coex policy may have the largest impact on WiFi performance, and may be used in platforms with low antenna isolation (e.g., smaller size devices). The TDD coex policy can offer a full BT range. The hybrid coex policy can be used on platforms with or without a dedicated BT antenna, and can offer better WiFi Rx performance than TDD. While using the hybrid policy, BT may be constrained by turning off some advanced BT features (e.g., ePA, TxBF, and MRC). The 2G parallel policy may be limited to platforms with high antenna isolation and a dedicated BT antenna, and the Tx power may be controlled. BT may be restricted to using the dedicated antenna, and BT may not have access to some BT features (e.g., ePA, TxBF). The 5G parallel policy is not dependent on antenna isolation when WiFi is on 5G. BT can get optimal performance as 5G WiFi does not apply any restrictions to BT in the 2G band.

In some embodiments, the wireless communication system can prevent BT from using power save during AWDL sessions. While the system is operating under the TDD policy, Clear-To-Send to self (CTS2S) may be implemented to hold WiFi traffic. While the system is operating under the hybrid policy, simultaneous WiFi/BT Rx/Rx is allowed, and WiFi is only allowed to Tx ACK during BT Tx/Rx. While using the hybrid policy, WiFi can ACK SISO data and BT can be limited to using one antenna for Tx/Rx. The wireless communication system 102 can strictly control the number of 2.4 GHz channels used in AWDL so that the BT performance impact is limited.

The wireless communication system 102 can generate a temporal sequence of slots (e.g., 64 ms slots) with a defined basic unit of time (e.g., 64 time units (TU)). A channel sequence can include a unit of 16 slots, resulting in a size of 1024 TU (i.e., 1 second). In some embodiments, AWDL can use default operating channels (e.g., channel 149 on 5 GHz, and channel 6 on 2.4 GHz). In some embodiments, the wireless communication system 102 can use a placeholder (e.g., channel 0) to indicate AWDL is not operating in the slot. For example, WiFi Infra can use channel 11, and AWDL can use 5 GHz channel 149 and 2.4 GHz channel 6. Table 3, below, lists an example channel sequence.

TABLE 3
Example AWDL/Infra Channel Sequence

| Slot | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| Chan# | 149 | 149 | 149 | 0 | 0 | 0 | 11 | 11 | 6 | 149 | 149 | 0 | 0 | 0 | 11 | 11 |

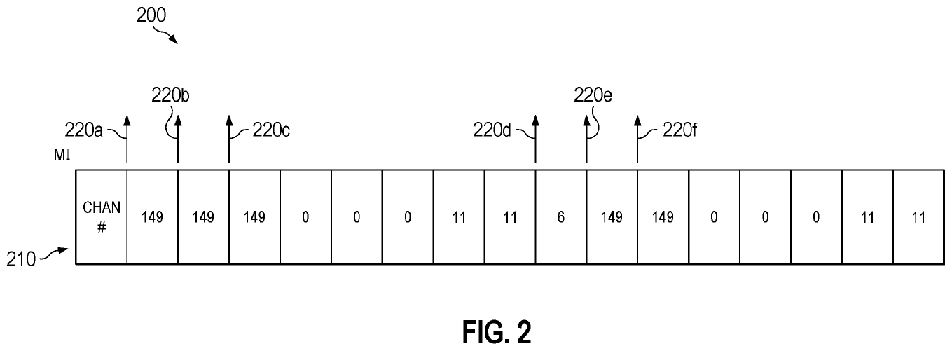

FIG. 2 illustrates an example 200 of sending action frames to synchronize among devices. The example 200 can include a sequence 210 of slots and action frames 220a-e. Each of the action frames 220a-e can include a Period Synchronization Frame (PSF) and/or a Master Indication (MI). A wireless communication system can send a PSF asynchronous to the channel sequence on at least one social channel (e.g., channel 6 and/or 149). At least one PSF may be sent best effort (e.g., every 110 ms). The wireless communication system can send an MI synced to the channel sequence (e.g., in every non-zero slot). Each MI can be critical and can occur at the first 16 TU of every 64 TU slot.

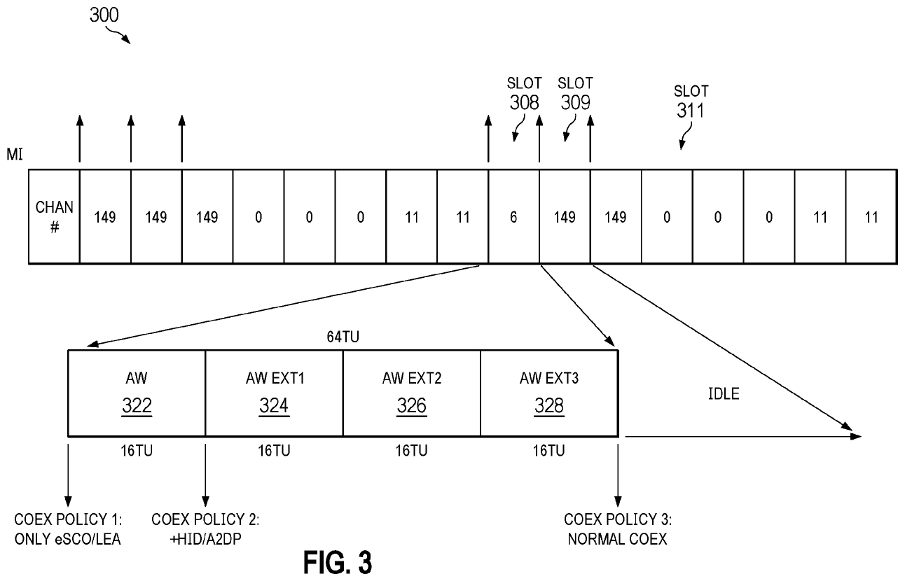

FIG. 3 illustrates an example 300 of a channel sequence for a coexistence (coex) scheme. In example 300, AWDL is in the 2.4 GHz channel 6 at slot 308. The slot 308 includes 64 TU divided into four 16 TU. For example, the wireless communication system can divide slots when WiFi is in 2.4 GHz for AWDL and BT is in operation.

The 1st 16TU subdivision includes the Available Window (AW) 312. In some embodiments, AW 312 is critical for AWDL MI, and only critical BT packets (e.g., enhanced synchronous connection-oriented [eSCO], low energy audio [LEA]) are allowed by the BT coex policy during AW 312. The remaining 16 TU subdivisions including AW ext1 314, AW ext2 316, and AW ext3 318 can be used for additional BT traffic (e.g., Advanced Audio Distribution Profile [A2DP], Human Interface Devices [HIDs]). In some embodiments, BT scan can be suppressed (i.e., not allowed) while AWDL is in 2.4 GHz channel 6. The wireless communication system can use a normal coex in slot 309 and slot 311 when AWDL is not in channel 6. AWDL can be in channel 149 at slot 309 and channel 0 at slot 311. In some embodiments, the wireless communication system can use a normal coex when WiFi Infra is in 5 GHz.

### Parallel Coex Policy

Returning to FIG. 1, the wireless communication system 102 can control the radio 112 and the radio 114 according to a parallel coexistence policy. The wireless communication system 102 can instruct the radios 112 and 114 to simultaneously use two different wireless protocols on two different radio frequency (RF) bands (e.g., 2.4 GHz, 5 GHz). One wireless protocol can be used to send and receive data on one RF band, and the second wireless protocol can be used to send and receive data on the second RF band. Once the RF band usage is established, each band can be used without any restrictions from the other wireless protocol. For example, AWDL and BT can operate completely independent from each other. In such an example, AWDL and BT can Tx/Rx any packet at any time without coordinating with the other protocol, and can operate as if the other is not present.

In some embodiments, the wireless communication system can determine bands for the radios 112 and 114 based on scheduling. For example, a first schedule can be determined for a first wireless protocol. The first schedule can include which band the first wireless protocol will use during time periods. For example, the schedule can include the next 1024 ms. The time periods can each be a segment (e.g., 64 ms) of the schedule (e.g., 1024 ms). A second schedule can be determined for the second wireless protocol to use a different frequency band then the first wireless protocol will use during the time periods. In some embodiments, the segment size (e.g., packet size) for the second wireless protocol can be different than the segment size (e.g., packet size) for the second wireless protocol. For example, the segment size for the second wireless protocol can include a variable size (e.g., 1.25 ms to 64 ms). In some embodiments, the first and second wireless protocols can use the same frequency band for a transition time period (e.g., in response to segments ending at different times.) The wireless communication system can instruct the radio 112 to send and receive data using the first wireless protocol according to the first schedule, and instruct the radio 114 to send and receive data using the second wireless protocol according to the second schedule.

### Coex Using 2G and 5G

In some embodiments, the wireless communication system 102 can use a channel sequence entirely in the 5 GHz band for a first wireless protocol (e.g., AWDL, NAN) to send and receive data. In such embodiments, the channel sequence does not use the 2.4 GHz band, and a second wireless protocol (e.g., BT) can fully use the 2.4 GHz band. For example, an entire channel sequence for the first wireless protocol can use channel 149 (e.g., without using channel 6). In some examples, the wireless communication system can send and receive data without restricting BT features. In some embodiments, the wireless communication system can determine not to use 2G for the first wireless protocol in response to determining that other devices are capable of SDB. In such embodiments, the wireless communication system can skip sending and/or receiving data using the first wireless protocol with a device only capable of 2G. In some embodiments, the wireless communication system can skip communicating with a device that is unable to use the first wireless protocol.

In some embodiments, the second wireless protocol can use a shared antenna without restrictions or conflicts from the first wireless protocol. For example, the radio 112 can Tx/Rx communications for the first wireless protocol using 5G, and the radio 114 can Tx/Rx communications for the second wireless protocol using 2G. In some embodiments, the radio 114 can operate as if the radio 112 is powered off. In such embodiments, the second wireless protocol can be used even if the environment has poor antenna isolation. For example, the radio 114 can access both a shared antenna and a dedicated antenna (e.g., dedicated BT antenna). In some examples, BT and AWDL can use at least one shared antenna in parallel operation with AWDL operating on the 5G band, and BT in the 2G band so that they do not interfere with each other.

In some embodiments, the wireless communication system 102 can instruct the radios 112 and 114 to simultaneously use two different antennas to use the two wireless protocols on the same RF band (e.g., 2.4 GHz, 5 GHz). In some examples, the second wireless protocol is restricted from using at least one shared antenna. In such examples, the first wireless protocol can use the shared antenna. In some examples, the second wireless protocol can use a dedicated antenna (e.g., a dedicated BT antenna). In some embodiments, at least one feature of the second wireless protocol can be disabled. In some embodiments, the wireless communication system 102 can determine that the environment 100 includes at least two antennas with high isolation (e.g., low interference, low feedback, low noise) from each other. In some embodiments, the wireless communication system can limit the transmit power of the two antennas to increase clarity of each signal.

### 2G Control Signal

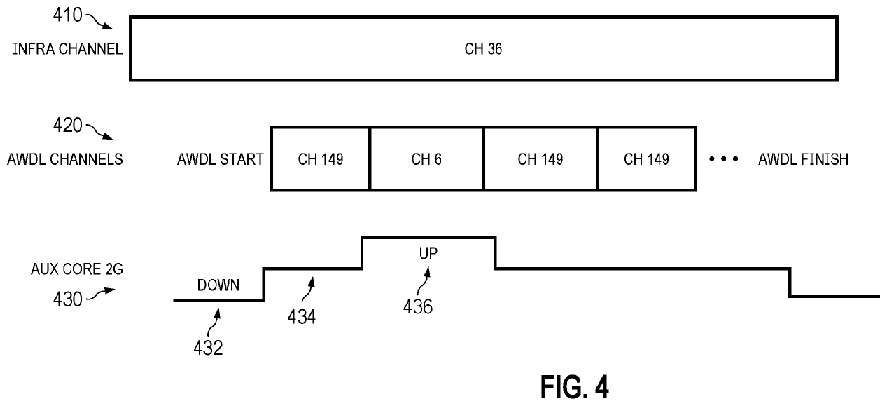

FIG. 4 illustrates an example 400 of a relationship between an AWDL channel sequence and the state of a 2G Core. The WiFi infra channel 410 is in 5 GHz (e.g., Ch 36) and AWDL is on. The AWDL channels 420 sequence includes channel 6. The Aux Core 2G 430 can be down at 432 before AWDL starts. The Aux Core 2G 430 can be in an intermediate state at 434 (e.g., a state between up and down) while AWDL is in 5 GHz (e.g., channel 149), and in an up state at 436 while AWDL is in 2.4 GHz (e.g., channel 6). The intermediate state can indicate that an AWDL session is active, but ADWL is not using the 2.4 GHz band. In some embodiments, the up state can indicate that the WiFi infra channel 410 includes a channel in 2.4 GHz. In some embodiments, the Aux Core 2G 430 can be in the up state during a WiFi scan including a channel in 2.4 GHz.

In some embodiments, the wireless communication system can use the parallel coex policy while the Aux Core 2G 430 is in the intermediate state at 434. If the first wireless protocol (e.g., AWDL) uses channel 149 for most of a sequence, then the second wireless protocol (e.g., BT) can use the parallel coex policy for most of the time (e.g., all but one 64TU slot).

In some embodiments, the Aux Core 2G 430 can be in a down state at 434 so that the wireless communication system can use the parallel coexistence policy for portions of the AWDL sessions in which AWDL is in channel 149. For example, the switching time of the Aux Core 2G 430 can be decreased (e.g., to less than 64 ms) so that the Aux Core 2G 430 will remain in the intermediate state for less than a 64TU slot while AWDL is in channel 149. In some embodiments, the second wireless protocol can use a channel 6 coex policy during the whole AWDL session for any session which includes channel 6. For example, the wireless communication system can use the hybrid coex policy while AWDL is in channel 149. In some examples, the wireless communication system can use the TDD coex policy while AWDL is in channel 149.

### Time Sharing Coex Policy

Returning to FIG. 1, the wireless communication system 102 can control the radio 112 and the radio 114 according to a time sharing coexistence policy. The radios 112 and 114 can take turns controlling antenna 140. The wireless communication system 102 can control the radio 112 to use the antenna 140 at a first time for transmission according to the first wireless policy. The wireless communication system 102 can control the radio 114 to use the antenna 140 at a second time for transmission according to the second wireless policy.

### TDD Coex Policy

In some embodiments, the time sharing coex policy can include a TDD (time division duplex (TDD) coex policy. The wireless communication system 102 can control the radio 112 and the radio 114 to share the antenna 140 by time division duplexing. For example, AWDL and BT can take turns transmitting and receiving data, with only one radio (e.g., radio 112 for AWDL and radio 114 for BT) accessing the ANTs at a time. In such embodiments, BT can access the shared ANT, but must split time with AWDL.

In some embodiments, the TDD coex policy can be used when AWDL is in certain channels (e.g., when AWDL is using a channel in the 2.4 GHz band). For example, BT and AWDL can use time division for all communications when AWDL is using a 2.4 GHz band. In some embodiments, the wireless communication system 102 can switch to the parallel coex policy when AWDL is not using 2G.

In some embodiments, the wireless communication system 102 can determine to use TDD based on environment 100 having low antenna isolation (e.g., antennas are close together in a small-sized device). BT can use the at least one shared antenna, but only at certain times.

In some embodiments, the wireless communication system 102 can use the TDD coex policy to balance the performance (e.g., latency, throughput) between WiFi Infra, AWDL, and BT. For example, the wireless communication system 102 can set the coex mode as TDD when WiFi Infra is using 5 GHz. In some embodiments, the wireless communication system 102 can enable BT features. For example, the full BT range can be enabled. BT performance may be minimally impacted when AWDL is on, since most of AWDL channels are in 5 GHz, whether WiFi Infra is in 2.4 GHz or 5 GHz. In some embodiments, the impact on the performance of WiFi Infra may be minimized when WiFi Infra is in 2.4 GHz by maintaining a low latency mode. For example, for low latency apps (e.g., side car, universal control) the TDD coex policy can be overridden by the low latency mode. The impact on WiFi performance may be less than BT performance impact. For example, WiFi may be impacted at most in one of sixteen slots as compared to BT, which may get impacted all the time.

### Hybrid Coex Policy

In some embodiments, the time sharing coex policy can include a hybrid coex policy. The wireless communication system 102 can control radios 112 and 114 so that the first communication protocol can receive 2G traffic at the same time that the second communication protocol sends and receives data. For example, the wireless communication system 102 can use time division when AWDL and BT both need to transmit data, but allow AWDL to receive data simultaneously with BT. In some embodiments, AWDL can transmit acknowledgments and receive data simultaneously with certain BT communications. The throughput of received WiFi data can be improved. The hybrid coex policy can be used on platforms with or without a dedicated BT antenna. The performance may be best when a dedicated antenna is available. A WiFi ACK (e.g., required for received packets) can be transmitted at the same time as BT traffic. In some embodiments, the wireless communication system 102 can use the TDD coex policy for WiFi data packet transmissions.

In some embodiments, the wireless communication system 102 can disable BT features based on the available hardware. In some embodiments, the environment 100 includes only two antennas and both are shared. The wireless communication system 102 can control the radio 114 to use BT eLNA and/or ePA on a limited basis. For example, BT ePA can be limited to BT retransmit packets. In some embodiments, the environment 100 has three antennas with one dedicated BT antenna. The wireless communication system 102 can control the radio 114 to use TxBF and MRC between the dedicated antenna and one of the shared antennas. The wireless communication system 102 can utilize the dedicated BT antenna even if the dedicated BT antenna is not capable of ePA. The TxBF performance may be better than with a single antenna, but may not be as good as if both chains had ePA. In some embodiments, AWDL and BT must share one antenna. In such embodiments, the wireless communication system 102 can restrict BT from using ePA. In some embodiments, BT can use a shared antenna and a dedicated BT antenna.

### Targeted Communications

In some embodiments, the wireless communication system 102 can determine whether to communicate with other devices according to targeted criteria. In some embodiments, a session for the first wireless protocol can be triggered in response to a scan. For example, the scan can be a BT low energy (BTLE) scan. The scan may result in an unnecessary number of sessions.

In some embodiments, the targeted criteria can include an accept list and/or deny list, which can be used to filter devices. For example, devices can be filtered according to categories. The categories can include “content only with nobody”, “content only”, and “everybody”. The accept list can include destination addresses of devices. Triggering the first wireless protocol can be limited to the filtered devices. In some embodiments, the accept list can be determined based on a distance between the wireless communication system 102 and other devices. For example, BTLE Received Signal Strength Indicator (RSSI) can be used as the filter. If the category is set to everybody, the wireless communication system 102 can limit connections to devices meeting the RSSI. In some embodiments, the wireless communication system 102 can add devices which are too far away to a deny list. For example, a bubble can be set to 75 feet, and the wireless communication system 102 can limit connections to devices within the bubble.

In some embodiments, a session for the first wireless protocol can be triggered according to a schedule determined in advance. In some embodiments, the wireless communication system 102 can determine to skip initiating AWDL in response to scans from some devices. The wireless communication system 102 can suppress scanning (e.g., location scan, roam scan) if AWDL/NAN is doing low latency apps.

In some embodiments, the wireless communication system 102 can determine the accept list based on a policy for AWDL. In some embodiments, the AWDL policy can bypass BTLE and be more user friendly by reducing unwanted AWDL sessions. For example, the accept list can be limited to other devices which the wireless communication system 102 asks for. In such an example, AWDL sessions can be limited to devices which the user asks to connect with.

In some embodiments, the targeted criteria can be dynamic. For example, the targeted criteria can be location based (e.g., home, office). For example, the accept list can be limited to “contacts only” while at the office. An office may include a large number of other devices with the potential to trigger AWDL sessions, and the user may only want to communicate with selected devices. There may be a small number of devices at home, and the user may wish to be able to connect with all the devices. In some embodiments, the targeted criteria can be adjusted based on connection ability. For example, the wireless communication system 102 may have a higher connection quality with other devices at a certain location (e.g., determined using BTLE RSSI).

In some embodiments, the targeted criteria can be learned using machine learning. For example, a machine learning model can learn user preferences (e.g., hobbies, working style, learning style), and adjust the targeted criteria accordingly. For example, the model may learn a number of devices that the user connects to at different locations, and adjust the criteria to limit connections in locations in which the user does not connect to a high number of other devices. The machine learning model can be trained on remote hardware (e.g., server).

### Benefits of the Approaches

Table 4, below, list approaches for improving the coexistence between AWDL and BT.

TABLE 4
Coex Approaches

| Approaches | Benefits | Requirements | Note |
|---|---|---|---|
| Remove Ch 6 in | BT can leverage | Once all devices are | Cleanest solution |
| AWDL Sequence | full features | SDB capable, it is | |
| | | feasible | |
| Add BTLE filters | AWDL will be | BT host SW needs to | Mitigation solution, big |
| to suppress AWDL | on until target | add grant list to restrict | benefit in office use |
| sessions | device is found | AWDL triggering, it can | |
| | | also add BT RSSI check | |
| | | to filter weak BT RSSI | |
| Aux 2 G core to | BT impact will be | Work with the chip | WiFi FW solution |
| be down if not | limited to 2.4 GHz | vendor to implement it | |
| in 2.4 GHz | only | | |
| AWDL in TDD | BT can leverage | Limit TDD mode when | Not the best solution as |
| mode only | full features | AWDL has no data | it can impact WiFi perf |
| | | involved | potentially |
| Add advanced BT | BT can leverage | (1) turn on BT ePA for | It requires factory |
| features in | advanced features | reTx packets in the | calibration; unbalanced |
| hybrid mode | | shared chain (2) enable | BT chains (shared vs. |
| | | TxBF between | dedicated) may provide |
| | | dedicated and shared BT | compromised perf |
| | | chains | |

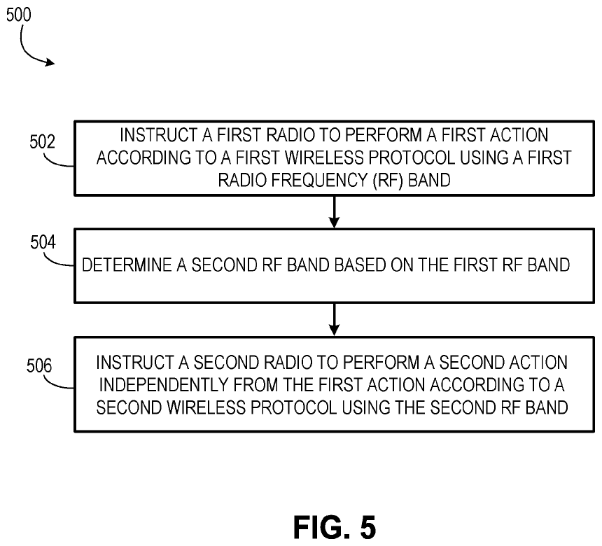

FIG. 5 illustrates a flowchart of an example method 500, according to some implementations of the present disclosure. For clarity of presentation, the description that follows generally describes method 500 in the context of the other figures in this description. However, it will be understood that method 500 can be performed, for example, by any suitable system, environment, software, hardware, or a combination of systems, environments, software, and hardware, as appropriate. In some implementations, various operations of method 500 can be run in parallel, in combination, in loops, or in any order.

At 502, method 500 involves instructing a first radio to perform a first action according to a first wireless protocol using a first radio frequency (RF) band. The first radio is communicatively coupled to at least one antenna, and the first radio operates according to the first wireless protocol. Further, the first radio and a second radio simultaneously access the at least one antenna.

At 504, method 500 involves determining a second RF band based on the first RF band. In some implementations, determining a second RF band includes obtaining a schedule corresponding to the first wireless protocol. The schedule includes the first radio using the first RF band at a time of performing the first action. The second RF band is determined so that it is different from the first RF band at the time of performing the first action.

At 506, method 500 involves instructing a second radio to perform a second action according to a second wireless protocol using the second RF band. The second radio is communicatively coupled to the at least one antenna, and the second radio operates according to the second wireless protocol.

In some implementations, the first action and second action include transmitting data packets using the at least one antenna.

In some implementations, the first wireless protocol is a peer to peer (P2P) protocol, and the second wireless protocol is a Bluetooth protocol.

In some implementations, the first wireless protocol is restricted from using the second RF band.

In some implementations, the second wireless protocol can use the at least one shared antenna without restriction.

In some implementations, the at least one antenna includes at least one antenna dedicated to the second wireless protocol, and at least one shared antenna.

In some implementations, the actions further include determining the first wireless protocol is using the second RF band. In response to determining the first wireless protocol is using the second RF band, the second wireless protocol is restricted to use at least one antenna dedicated to the second wireless protocol.

In some implementations, the actions further include determining a time period for which the first protocol requires the second RF band. The second radio is restricted from performing the second action during the time period.

In some implementations, the actions further include determining the first wireless protocol is not using the second RF band. In response to determining the first wireless protocol, the second wireless protocol is allowed to use the at least one shared antenna without restriction.

In some implementations, determining the first wireless protocol is not using the second RF band includes determining a control signal for the second radio is in an intermediate state.

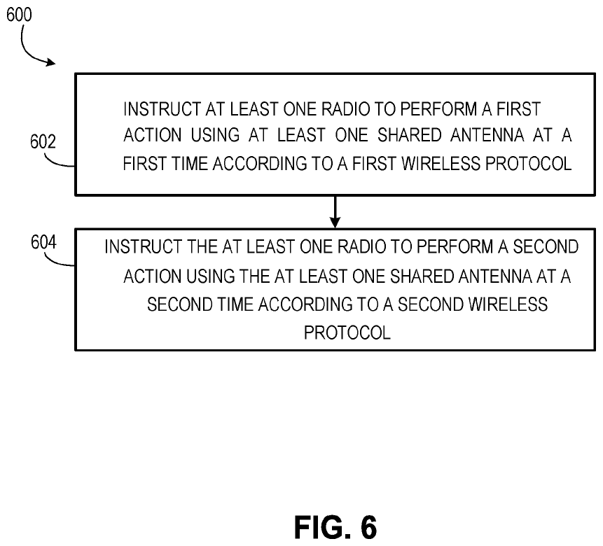

FIG. 6 illustrates a flowchart of an example method 600, according to some implementations of the present disclosure. For clarity of presentation, the description that follows generally describes method 600 in the context of the other figures in this description. However, it will be understood that method 600 can be performed, for example, by any suitable system, environment, software, hardware, or a combination of systems, environments, software, and hardware, as appropriate. In some implementations, various operations of method 600 can be run in parallel, in combination, in loops, or in any order.

At 602, method 600 involves instructing at least one radio to perform a first action using at least one shared antenna at a first time according to a first wireless protocol. The at least one radio is communicatively coupled to the at least one shared antenna via at least one data path.

At 604, method 600 involves instructing the at least one radio to perform a second action using the at least one shared antenna at a second time according to a second wireless protocol.

In some implementations, the first wireless protocol is a peer to peer (P2P) protocol, and the second wireless protocol is a Bluetooth protocol.

In some implementations, the actions further include determining the first wireless protocol does not require a shared radio frequency (RF) band to perform the first action. In response to determining the first wireless protocol does not require the shared RF band, the at least one radio is instructed to perform a third action using the at least one shared antenna at the first time according to the second wireless protocol.

In some implementations, the first action includes transmitting first data packets and receiving second data packets using the at least one shared antenna according to the first wireless protocol. In such implementations, the second action includes transmitting third data packets and receiving fourth data packets using the at least one shared antenna according to the second wireless protocol.

In some implementations, the actions further include determining whether at least one of the first wireless protocol and the second wireless protocol satisfy at least one threshold criterion. In response to determining the at least one threshold criterion is satisfied, the at least one radio is instructed to perform a set of first actions according to the first wireless protocol at different times than a set of second actions according to the second wireless protocol. In response to determining the at least one threshold criterion is not satisfied, the at least one radio is instructed to perform a subset of the first actions according to the first wireless protocol at the same time as a subset of the second actions according to the second wireless protocol.

In some implementations, the actions further include instructing the at least one radio to receive first data packets using the at least one shared antenna at a third time according to the first wireless protocol. In such implementations, the at least one radio is instructed to receive second data packets using the at least one shared antenna at the third time according to the second wireless protocol independently from receiving the third data packets.

In some implementations, the actions further include instructing the at least one radio to receive data packets using the at least one shared antenna at the second time according to the first wireless protocol independently from the second action.

In some implementations, the actions further include instructing the at least one radio to transmit an acknowledgment of received data packets using the at least one shared antenna at the second time according to the first wireless protocol independently from the second action.

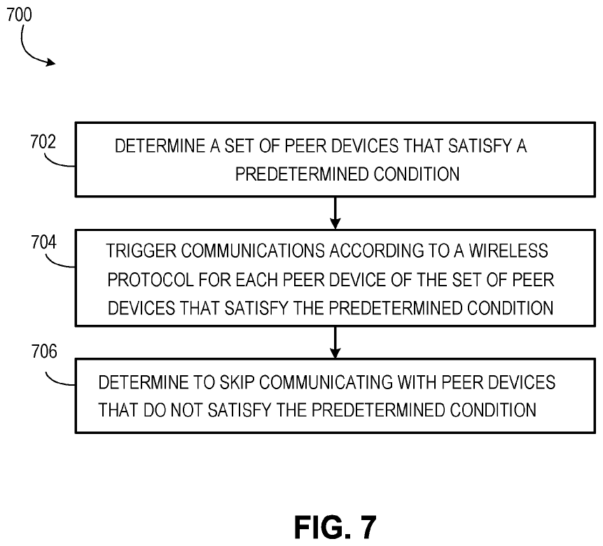

FIG. 7 illustrates a flowchart of an example method 700, according to some implementations of the present disclosure. For clarity of presentation, the description that follows generally describes method 700 in the context of the other figures in this description. However, it will be understood that method 700 can be performed, for example, by any suitable system, environment, software, hardware, or a combination of systems, environments, software, and hardware, as appropriate. In some implementations, various operations of method 700 can be run in parallel, in combination, in loops, or in any order.

At 702, method 700 involves determining a set of peer devices that satisfy a predetermined condition.

At 704, method 700 involves triggering communications according to a wireless protocol for each peer device of the set of peer devices that satisfy the predetermined condition.

At 706, method 700 involves determining to skip communicating with peer devices that do not satisfy the predetermined condition.

In some implementations, determining the set of peer devices that satisfy the predetermined condition includes scanning for peer devices on a wireless network.

FIG. 8 is a block diagram of an example computer system 800 that can be used to provide computational functionalities associated with described algorithms, methods, functions, processes, flows, and procedures described in the present disclosure, according to some implementations of the present disclosure.

The illustrated computer 802 is intended to encompass any computing device such as a server, a desktop computer, an embedded computer, a laptop/notebook computer, a wireless data port, a smartphone, a personal data assistant (PDA), a tablet computing device, or one or more processors within these devices, including physical instances, virtual instances, or both. The computer 802 can include input devices such as keypads, keyboards, and touch screens that can accept user information. Also, the computer 802 can include output devices that can convey information associated with the operation of the computer 802. The information can include digital data, visual data, audio information, or a combination of information. The information can be presented in a graphical user interface (UI) (or GUI). In some implementations, the inputs and outputs include display ports (such as DVI-I+2x display ports), USB 3.0, GbE ports, isolated DI/O, SATA-III (6.0 Gb/s) ports, mPCIe slots, a combination of these, or other ports. In instances of an edge gateway, the computer 802 can include a Smart Embedded Management Agent (SEMA), such as a built-in ADLINK SEMA 2.2, and a video sync technology, such as Quick Sync Video technology supported by ADLINK MSDK+. In some examples, the computer 802 can include the MXE-5400 Series processor-based fanless embedded computer by ADLINK, though the computer 802 can take other forms or include other components.

The computer 802 can serve in a role as a client, a network component, a server, a database, a persistency, or components of a computer system for performing the subject matter described in the present disclosure. The illustrated computer 802 is communicably coupled with a network 830. In some implementations, one or more components of the computer 802 can be configured to operate within different environments, including cloud-computing-based environments, local environments, global environments, and combinations of environments.

At a high level, the computer 802 is an electronic computing device operable to receive, transmit, process, store, and manage data and information associated with the described subject matter. According to some implementations, the computer 802 can also include, or be communicably coupled with, an application server, an email server, a web server, a caching server, a streaming data server, or a combination of servers.

The computer 802 can receive requests over network 830 from a client application (for example, executing on another computer 802). The computer 802 can respond to the received requests by processing the received requests using software applications. Requests can also be sent to the computer 802 from internal users (for example, from a command console), external (or third) parties, automated applications, entities, individuals, systems, and computers.

Each of the components of the computer 802 can communicate using a system bus 803. In some implementations, any or all of the components of the computer 802, including hardware or software components, can interface with each other or the interface 804 (or a combination of both), over the system bus. Interfaces can use an application programming interface (API) 812, a service layer 813, or a combination of the API 812 and service layer 813. The API can include specifications for routines, data structures, and object classes. The API can be either computer-language independent or dependent. The API can refer to a complete interface, a single function, or a set of APIs.

The service layer can provide software services to the computer 802 and other components (whether illustrated or not) that are communicably coupled to the computer 802. The functionality of the computer 802 can be accessible to all service consumers using this service layer. Software services, such as those provided by the service layer, can provide reusable, defined functionalities through a defined interface. For example, the interface can be software written in JAVA, C++, or a language providing data in extensible markup language (XML) format. While illustrated as an integrated component of the computer 802, in alternative implementations, the API or the service layer can be stand-alone components in relation to other components of the computer 802 and other components communicably coupled to the computer 802. Moreover, any or all parts of the API or the service layer can be implemented as child or sub-modules of another software module, enterprise application, or hardware module without departing from the scope of the present disclosure.

The computer 802 can include an interface 804. Although illustrated as a single interface 804 in FIG. 8, two or more interfaces 804 can be used according to particular needs, desires, or particular implementations of the computer 802 and the described functionality. The interface 804 can be used by the computer 802 for communicating with other systems that are connected to the network 830 (whether illustrated or not) in a distributed environment. Generally, the interface 804 can include, or be implemented using, logic encoded in software or hardware (or a combination of software and hardware) operable to communicate with the network 830. More specifically, the interface 804 can include software supporting one or more communication protocols associated with communications. As such, the network 830 or the interface's hardware can be operable to communicate physical signals within and outside of the illustrated computer 802.

The interface 804 may also include one or more antennas for communicating using one or more wireless communication protocols. In some cases, one or more parts of a receive and/or transmit chain may be shared between multiple wireless communication standards. For example, a device might be configured to communicate using either Bluetooth or WiFi using partially or entirely shared wireless communication circuitry (e.g., using a shared radio or at least shared radio components). The shared communication circuitry may include a single antenna, or may include multiple antennas (e.g., for MIMO) for performing wireless communications.

Alternatively, the interface 804 may include separate transmit and/or receive chains (e.g., including separate antennas and other radio components) for each wireless communication protocol with which it is configured to communicate. As a further possibility, the computer 802 may include one or more radios or radio components which are shared between multiple wireless communication protocols, and one or more radios or radio components which are used exclusively by a single wireless communication protocol. For example, the computer 802 may include a shared radio for communicating using one or more of LTE, CDMA2000 1×RTT, GSM, and/or 5G NR, and separate radios for communicating using each of WiFi and Bluetooth. Other configurations are also possible.

The computer 802 includes a processor 805. Although illustrated as a single processor 805 in FIG. 8, two or more processors 805 can be used according to particular needs, desires, or particular implementations of the computer 802 and the described functionality. Generally, the processor 805 can execute instructions and can manipulate data to perform the operations of the computer 802, including operations using algorithms, methods, functions, processes, flows, and procedures as described in the present disclosure.

The computer 802 can also include a database 806 that can hold data for the computer 802 and other components connected to the network 830 (whether illustrated or not). For example, database 806 can be an in-memory, conventional, or a database storing data consistent with the present disclosure. In some implementations, database 806 can be a combination of two or more different database types (for example, hybrid in-memory and conventional databases) according to particular needs, desires, or particular implementations of the computer 802 and the described functionality. Although illustrated as a single database 806 in FIG. 8, two or more databases (of the same, different, or combination of types) can be used according to particular needs, desires, or particular implementations of the computer 802 and the described functionality. While database 806 is illustrated as an internal component of the computer 802, in alternative implementations, database 806 can be external to the computer 802.

The computer 802 also includes a memory 807 that can hold data for the computer 802 or a combination of components connected to the network 830 (whether illustrated or not). Memory 807 can store any data consistent with the present disclosure. In some implementations, memory 807 can be a combination of two or more different types of memory (for example, a combination of semiconductor and magnetic storage) according to particular needs, desires, or particular implementations of the computer 802 and the described functionality. Although illustrated as a single memory 807 in FIG. 8, two or more memories 807 (of the same, different, or combination of types) can be used according to particular needs, desires, or particular implementations of the computer 802 and the described functionality. While memory 807 is illustrated as an internal component of the computer 802, in alternative implementations, memory 807 can be external to the computer 802.

An application 808 can be an algorithmic software engine providing functionality according to particular needs, desires, or particular implementations of the computer 802 and the described functionality. For example, an application can serve as one or more components, modules, or applications. Multiple applications can be implemented on the computer 802. Each application can be internal or external to the computer 802.

The computer 802 can also include a power supply 814. The power supply 814 can include a rechargeable or non-rechargeable battery that can be configured to be either user- or non-user-replaceable. In some implementations, the power supply 814 can include power-conversion and management circuits, including recharging, standby, and power management functionalities. In some implementations, the power-supply 814 can include a power plug to allow the computer 802 to be plugged into a wall socket or a power source to, for example, power the computer 802 or recharge a rechargeable battery.

There can be any number of computers 802 associated with, or external to, a computer system including computer 802, with each computer 802 communicating over network 830. Further, the terms “client,” “user,” and other appropriate terminology can be used interchangeably, as appropriate, without departing from the scope of the present disclosure. Moreover, the present disclosure contemplates that many users can use one computer 802 and one user can use multiple computers 802.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of an exchange file system can be done at application layer. Furthermore, Unicode data files can be different from non-Unicode data files.

While this specification includes many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below.

### Examples

In the following section, further exemplary embodiments are provided.

Example 1 includes one or more processors of a wireless device, the wireless device including a first radio that operates according to a wireless peer to peer (P2P) protocol and a second radio that operates according to a second wireless protocol, the one or more processors configured to cause the wireless device to perform operations including: determining, using device properties, whether to use the P2P protocol and the second wireless protocol in parallel; in response to determining to use the P2P protocol and the second wireless protocol in parallel, determining transmission characteristics for each of the P2P protocol and the second wireless protocol; instructing the first radio to perform a first action according to the P2P protocol and respective transmission characteristics; and instructing the second radio to perform a second action according to the second wireless protocol and respective transmission characteristics.

Example 2 is the one or more processors of Example 1, where the transmission characteristics include, for each of the P2P protocol and the second wireless protocol, at least one of: at least one antenna characteristic, a radio frequency (RF) band, a stream, and protocol features.

Example 3 is the one or more processors of any preceding Example, where determining the transmission characteristics includes: obtaining a schedule corresponding to the P2P protocol, where the schedule includes the first radio using a first RF band at a time of performing the first action; and determining a second RF band to be different from the first RF band at the time of performing the first action.

Example 4 is the one or more processors of Example 3, where the P2P protocol is restricted from using the second RF band, and the second wireless protocol is allowed to use at least one antenna without restriction.

Example 5 is the one or more processors of any preceding Example, where the first action and the second action include transmitting data packets using at least one antenna.

Example 6 is the one or more processors of any preceding Example, where the second wireless protocol is a Personal Area Network (PAN) protocol.

Example 7 is the one or more processors of any preceding Example, where the at least one antenna includes: at least one antenna dedicated to the second wireless protocol; and at least one shared antenna.

Example 8 is the one or more processors of Example 7, further including: determining the P2P protocol is using an RF band; and in response to determining the P2P protocol is using the RF band, restricting the second wireless protocol to use the at least one antenna dedicated to the second wireless protocol.

Example 9 is the one or more processors of any preceding Example, the operations further including: determining a time period for which the P2P protocol requires the RF band; and restricting the second radio from performing the second action during the time period.

Example 10 is the one or more processors of Example 9, the operations further including: determining the P2P protocol is not using a second RF band, in response to determining the P2P protocol, allowing the second wireless protocol to use the at least one antenna without restriction.

Example 11 is the one or more processors of Example 10, where determining the P2P protocol is not using the second RF band includes: determining a control signal for the second radio is in an intermediate state.

Example 12 includes a wireless device including: at least one antenna; a first radio and a second radio communicatively coupled to the at least one antenna, the first radio operating according to a wireless peer to peer (P2P) protocol and the second radio operating according to a second wireless protocol; at least one processor configured to perform operations including: determining, using device properties, whether to use the P2P protocol and the second wireless protocol in parallel; in response to determining to use the P2P protocol and the second wireless protocol in parallel, determining transmission characteristics for each of the P2P protocol and the second wireless protocol; instructing the first radio to perform a first action according to the P2P protocol and respective transmission characteristics; and instructing the second radio to perform a second action according to the second wireless protocol and respective transmission characteristics.

Example 13 may include a non-transitory computer storage medium encoded with instructions that, when executed by one or more computers, cause the one or more computers to perform the operations of any of Examples 1 to 11.

Example 14 may include a system including one or more computers and one or more storage devices on which are stored instructions that are operable, when executed by the one or more computers, to cause the one or more computers to perform the operations of any of Examples 1 to 11.

Example 15 may include a processor for a wireless device including circuitry to execute one or more instructions that, when executed, cause the processor to perform the operations of any of Examples 1 to 11.

Example 16 may include a method for performing the operations of any of Examples 1 to 11.

The previously-described operations of Examples 1-11 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors of a wireless device, the one or more processors configured to cause the wireless device to perform operations comprising:
determining, using device properties, whether to use a wireless peer to peer (P2P) protocol and a second wireless protocol in parallel;
in response to determining to use the wireless P2P protocol and the second wireless protocol in parallel, determining transmission characteristics for each of the wireless P2P protocol and the second wireless protocol;
instructing a first radio of the wireless device to perform a first action according to the wireless P2P protocol and respective transmission characteristics; and
instructing a second radio of the wireless device to perform a second action according to the second wireless protocol and respective transmission characteristics.

2. The one or more processors of claim 1, wherein the transmission characteristics comprise, for each of the wireless P2P protocol and the second wireless protocol, at least one of: at least one antenna characteristic, a radio frequency (RF) band, a stream, and protocol features.

3. The one or more processors of claim 1, wherein determining the transmission characteristics comprises:
obtaining a schedule corresponding to the wireless P2P protocol, wherein the schedule comprises the first radio using a first RF band at a time of performing the first action; and
determining a second RF band to be different from the first RF band at the time of performing the first action.

4. The one or more processors of claim 3, wherein:
the wireless P2P protocol is restricted from using the second RF band, and
the second wireless protocol is allowed to use at least one antenna without restriction.

5. The one or more processors of claim 1, wherein the first action and the second action comprise transmitting data packets using at least one antenna.

6. The one or more processors of claim 1, wherein the second wireless protocol is a Personal Area Network (PAN) protocol.

7. The one or more processors of claim 5, wherein the at least one antenna comprises:
at least one antenna dedicated to the second wireless protocol; and
at least one shared antenna.

8. The one or more processors of claim 7, further comprising:
determining the wireless P2P protocol is using an RF band; and
in response to determining the wireless P2P protocol is using the RF band, restricting the second wireless protocol to use the at least one antenna dedicated to the second wireless protocol.

9. The one or more processors of claim 8, the operations further comprising:
determining a time period for which the wireless P2P protocol requires the RF band; and
restricting the second radio from performing the second action during the time period.

10. The one or more processors of claim 9, the operations further comprising:
determining the wireless P2P protocol is not using a second RF band,
in response to determining the wireless P2P protocol, allowing the second wireless protocol to use the at least one antenna without restriction.

11. The one or more processors of claim 10, wherein determining the wireless P2P protocol is not using the second RF band comprises:
determining a control signal for the second radio is in an intermediate state.

12. A wireless device comprising:
at least one antenna;
a first radio and a second radio communicatively coupled to the at least one antenna, the first radio configured to operate according to a wireless peer to peer (P2P) protocol and the second radio configured to operate according to a second wireless protocol;
at least one processor configured to perform operations comprising:
determining, using device properties, whether to use the wireless P2P protocol and the second wireless protocol in parallel;
in response to determining to use the wireless P2P protocol and the second wireless protocol in parallel, determining transmission characteristics for each of the wireless P2P protocol and the second wireless protocol;
instructing the first radio to perform a first action according to the wireless P2P protocol and respective transmission characteristics; and
instructing the second radio to perform a second action according to the second wireless protocol and respective transmission characteristics.

13-16. (canceled)

17. The wireless device of claim 12, wherein the transmission characteristics comprise, for each of the wireless P2P protocol and the second wireless protocol, at least one of: at least one antenna characteristic, a radio frequency (RF) band, a stream, and protocol features.

18. The wireless device of claim 12, wherein determining the transmission characteristics comprises:
obtaining a schedule corresponding to the wireless P2P protocol, wherein the schedule comprises the first radio using a first RF band at a time of performing the first action; and
determining a second RF band to be different from the first RF band at the time of performing the first action.

19. The wireless device of claim 18, wherein:
the wireless P2P protocol is restricted from using the second RF band, and
the second wireless protocol is allowed to use the at least one antenna without restriction.

20. The wireless device of claim 12, wherein the first action and the second action comprise transmitting data packets using the at least one antenna.

21. A non-transitory computer storage medium encoded with instructions that, when executed by one or more computers, cause the one or more computers to perform the operations of claim 1.

22. A system comprising one or more computers and one or more storage devices on which are stored instructions that are operable, when executed by the one or more computers, to cause the one or more computers to perform the operations of claim 1.

23. A processor for a wireless device comprising circuitry to execute one or more instructions that, when executed, cause the processor to perform the operations of claim 1.

24. A method for performing the operations of claim 1.
